(19) United States
(12) Patent Application Publication
(10) Pub. No.: US 2023/0307747 A1
(43) Pub. Date: Sep. 28, 2023

(54) ELECTROCHEMICAL OXYGEN REDUCTION CATALYST, AIR ELECTRODE, FUEL CELL AND METAL-AIR CELL

(71) Applicant: TOYOTA JIDOSHA KABUSHIKI KAISHA, Toyota-shi (JP)

(72) Inventor: Keiichi OKUBO, Toyota-shi (JP)

(21) Appl. No.: 18/174,704

(22) Filed: Feb. 27, 2023

(30) Foreign Application Priority Data
Mar. 28, 2022 (JP) 2022-051200

(51) Int. Cl. H01M 12/06; H01M 4/62; H01M 4/90; H01M 8/1018

(52) U.S. Cl. CPC H01M 12/06; H01M 4/62; H01M 4/9016; H01M 8/1018; H01M 2300/0082; H01M 2300/0085

(57) ABSTRACT

There is provided an electrochemical oxygen reduction catalyst containing metal particles having oxygen reduction activity and an additive, in which the additive is at least one organic nitrogen compound, and a ratio of a weight of the additive to a weight of the metal particles is more than 0 and less than 0.46.

### CROSS-REFERENCE TO RELATED APPLICATION

This application claims priority to Japanese Patent Application No. 2022-051200 filed on Mar. 28, 2022, incorporated herein by reference in its entirety.

### BACKGROUND

### 1. Technical Field

The present disclosure relates to an electrochemical oxygen reduction catalyst, an air electrode, a fuel cell and a metal-air cell.

### 2. Description of Related Art

Various studies have been carried out on electrochemical oxygen reduction catalysts.

WO 2019/221156 discloses a catalyst for electrochemical oxygen reduction, which contains at least one selected from the group consisting of a nanoparticle containing platinum, a melamine compound, a thiocyanuric acid compound, and a polymer containing the melamine compound or the thiocyanuric acid compound as a monomer.

### SUMMARY

In a case where an additive is added to a catalyst, there is a problem that the additive coats the surface of the metal particles having catalytic activity, and the reaction sites of the catalyst are reduced, which decreases the performance of the catalyst.

The present disclosure provides an electrochemical oxygen reduction catalyst that can improve catalytic activity.

An electrochemical oxygen reduction catalyst of a first aspect of the present disclosure contains metal particles having oxygen reduction activity and an additive.

The additive is at least one organic nitrogen compound.

The ratio of the weight of the additive to the weight of the metal particles is more than 0 and less than 0.46.

In the first aspect of the present disclosure, the ratio of the weight of the additive to the weight of the metal particles may be 0.052 or more and 0.1 or less.

An electrochemical oxygen reduction catalyst of a second aspect of the present disclosure contains metal particles having oxygen reduction activity and an additive.

The additive is at least one organic nitrogen compound.

The surface modification rate of the metal particles with the additive is less than 28%.

In the above-described aspects of the present disclosure, the organic nitrogen compound may be a monomer represented by General Formula (1), or a polymer at least partially containing the monomer.

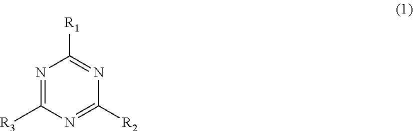

[In General Formula (1), R₁, R₂, and R₃ are each an amino group, a thiol group, a hydroxyl group, an alkylamino group having 1 to 10 carbon atoms, or an alkyl group having 1 to 10 carbon atoms, and each have at least one atom selected from the group consisting of an oxygen atom, a sulfur atom, a nitrogen atom, a fluorine atom, a chlorine atom, a bromine atom, an iodine atom, and a hydrogen atom.]

In the above-described aspects of the present disclosure, the metal particle may be at least one selected from the group consisting of a platinum particle, a platinum alloy particle, and a composite particle containing platinum.

In the above-described aspects of the present disclosure, a carrier may be further contained, and the metal particles may be supported on the carrier.

An air electrode of a third aspect of the present disclosure includes the electrochemical oxygen reduction catalyst and a polymer electrolyte having an ion exchange group.

An air electrode of a third aspect of the present disclosure may be for a fuel cell or a metal-air cell.

A fuel cell of a fourth aspect of the present disclosure has the air electrode as a cathode.

A metal-air cell of a fifth aspect of the present disclosure has the air electrode as a cathode.

According to the aspects of the present disclosure, it is possible to provide an electrochemical oxygen reduction catalyst that can improve catalytic activity.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a graph showing a relationship between a weight of an additive with respect to a weight of metal particles and an improvement rate of catalyst mass activity; and

FIG. 2 is a graph showing a relationship between a surface modification rate and the improvement rate of the catalyst mass activity.

### DETAILED DESCRIPTION OF EMBODIMENTS

Embodiments according to the present disclosure will be described below. It is noted that matters other than matters particularly referred to in the present specification and demanded for carrying out the present disclosure (for example, a general configuration and manufacturing process of the electrochemical oxygen reduction catalyst, which do not characterize the present disclosure) may be understood as a design matter for persons skilled in the art based on the related art in the related field. The present disclosure can be carried out based on the contents disclosed in the present specification and the common general technical knowledge in the field.

In the present specification, “to” indicating a numerical range is used to mean that numerical values described before and after “to” are included as a lower limit value and an upper limit value, respectively.

In addition, in a numerical range, any combination of an upper limit value and a lower limit value can be employed.

1. Electrochemical Oxygen Reduction Catalyst

In a first embodiment of the present disclosure, there is provided an electrochemical oxygen reduction catalyst characterized by containing metal particles having oxygen reduction activity and an additive, in which the additive is at least one organic nitrogen compound and a ratio of a weight of the additive to a weight of the metal particles is more than 0 and less than 0.46.

In a second embodiment of the present disclosure, there is provided an electrochemical oxygen reduction catalyst characterized by containing metal particles having oxygen reduction activity and an additive, in which the additive is at least one organic nitrogen compound, and a surface modification rate of the metal particles with the additive is less than 28%.

By reducing the amount of the additive in the electrochemical oxygen reduction catalyst of the present disclosure, it is possible to improve the catalytic activity, which is the effect of addition, while ensuring the quantity of reaction sites.

The electrochemical oxygen reduction catalyst of the present disclosure may satisfy at least any one of the conditions of (1) the ratio of the weight of the additive to the weight of the metal particles in the specific range and (2) the surface modification rate of the metal particles with the additive in the specific range or may satisfy both of the conditions.

The electrochemical oxygen reduction catalyst of the present disclosure contains metal particles having oxygen reduction activity and an additive.

The additive is at least one organic nitrogen compound.

The organic nitrogen compound may be a compound that satisfies a nitrogen equivalent of 20 g·eq⁻¹ to 270 g·eq⁻¹ or may be a compound that satisfies a nitrogen equivalent of 20 g·eq⁻¹ to 70 g·eq⁻¹, where the nitrogen equivalent indicates a dry weight per mole of nitrogen.

The nitrogen equivalent can be calculated from the following expression. It is noted that in a case of a polymer, a nitrogen equivalent of a monomer of the polymer is regarded as the nitrogen equivalent of the polymer.

Nitrogen equivalent (g·eq⁻¹)=molecular weight (g/mol)/nitrogen substance amount in molecule (mol_{N}/mol)

The organic nitrogen compound may be a compound having an amine functional group, a compound having pyridine-type nitrogen, or a compound containing a triazine ring. The organic nitrogen compound may be a monomer represented by General Formula (1) or a polymer at least partially containing the monomer.

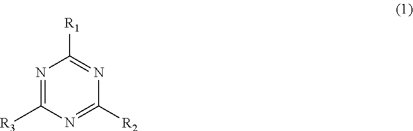

[In General Formula (1), R₁, R₂, and R₃ are each an amino group, a thiol group, a hydroxyl group, an alkylamino group having 1 to 10 carbon atoms, or an alkyl group having 1 to 10 carbon atoms, and each may have at least one atom selected from the group consisting of an oxygen atom, a sulfur atom, a nitrogen atom, a fluorine atom, a chlorine atom, a bromine atom, an iodine atom, and a hydrogen atom.]

R₁, R₂, and R₃ may each be a primary amine, a secondary amine, a tertiary amine, a quaternary ammonium cation, or a hydroxyl group.

The organic nitrogen compound may be a melamine compound (nitrogen equivalent: 21 g·eq⁻¹), a thiocyanuric acid compound (nitrogen equivalent: 59 g·eq⁻¹), a cyanuric acid compound (nitrogen equivalent: 34 g·eq⁻¹), oleylamine (nitrogen equivalent: 267 g·eq⁻¹), tetradecylamine (nitrogen equivalent: 213 g·eq⁻¹), 2,4,6-tris[bis(methoxymethyl)amino]-1,3,5-triazine (nitrogen equivalent: 65 g·eq⁻¹), 6-(dibutylamino)-1,3,5-triazine-2,4-dithiol (nitrogen equivalent: 68 g·eq⁻¹), 2,4-diamino-6-butylamino-1,3,5-triazine (nitrogen equivalent: 30 g·eq⁻¹), 2,4,6-tris(pentafluoroethyl)-1,3,5-triazine (nitrogen equivalent: 145 g·eq⁻¹), and polymers containing the compounds as monomers, as well as poly(melamine-co-formaldehyde) methylated (nitrogen equivalent: 20 g·eq⁻¹ to 40 g·eq⁻¹), poly(melamine-co-formaldehyde) isobutylated (nitrogen equivalent: 20 g·eq⁻¹ to 40 g·eq⁻¹), and the like.

In addition, two or more kinds of the above-described additives may be included.

As the melamine compound, the thiocyanuric acid compound, and the cyanuric acid compound, melamine, thiocyanuric acid, cyanuric acid, and derivatives thereof can be used without limitation.

Examples of the polymer containing the melamine compound, thiocyanuric acid compound, or cyanuric acid compound, as a monomer, include a melamine resin, thiocyanuric acid resin, or cyanuric acid resin, which has the above-described melamine compound, thiocyanuric acid compound, or cyanuric acid compound in the main chain of the repeating unit.

Among the above, the additive may be melamine (1,3,5-triazine-2,4,6-triamine) or a polymer of the melamine. In a case of a polymer, the adsorption stability is improved as compared with a case of a monomer since the polymer becomes difficult to desorb after adsorbing to metal particles.

The metal particle may be any metal having an oxygen reduction catalytic activity. Examples of the metal include platinum, ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium, and two or more kinds of these metals may be used. In addition, the metal may be an oxide, a nitride, a sulfide, or a phosphide.

Among the above, the metal particle may be at least one selected from the group consisting of a platinum particle, a platinum alloy particle, and a composite particle containing platinum.

Examples of metals other than the platinum contained in the platinum alloy and the composite particle containing platinum include ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium, and the metals may include two or more kinds of these metals.

The element ratio of the metals other than the platinum in the platinum alloy is not particularly limited and may be 0.11 atm % to 50 atm %.

The particle diameter (the particle size) of the metal particles is not particularly limited and may be 1 nm to 100 nm.

In the present disclosure, the particle size of particles is the average crystallite size measured according to the X-ray diffraction method.

The particle size of particles may be obtained by measuring the particle size of 100 to 1,000 particles with an electron microscope and taking the average value of these values as the average particle size of the particles. In the present disclosure, particle size was measured by the above two methods.

The electrochemical oxygen reduction catalyst of the present disclosure may contain a carrier such as carbon or an oxide.

The metal particles may be supported on a carrier.

The method of supporting metal particles on a carrier is not particularly limited, and a known method in the related art can be appropriately employed.

The carrier may be primary particles or secondary particles.

The particle size of the primary particles of the carrier may be, for example, 5 nm to 500 nm.

The metal support ratio of the metal particles supported on the carrier is not particularly limited and may be 1% to 50% or may be 18% to 48%.

The carrier may be carbon, an oxide, or the like, which has an electrical conductivity.

The carbon may be carbon black (acetylene black, Ketjen black, furnace black, or the like), activated carbon, graphite, glassy carbon, graphene, carbon fiber, carbon nanotube, carbon nitride, carbon sulfide, or carbon phosphide, or a mixture or the like containing at least two of these carbon materials.

The oxide may be a titanium oxide, a niobium oxide, a tin oxide, a tungsten oxide, or a molybdenum oxide, or a mixture containing at least two of these oxides.

Weight of Additive with Respect to Weight of Metal Particles

In the electrochemical oxygen reduction catalyst of the present disclosure, the ratio of the weight of the additive to the weight of the metal particles is more than 0 and less than 0.46 and may be 0.010 to 0.23.

Representative examples of methods of respectively measuring the weight of the additive and the weight of the contained metal particles are described below.

Evaluation Method for Weight of Additive

An evaluation method for the weight of the additive contained in the electrochemical oxygen reduction catalyst of the present disclosure includes a method of measuring the nitrogen content by a CHN elemental analysis, a method of extracting the additive from the electrochemical oxygen reduction catalyst and directly measuring the additive, and the like.

The method of measuring the nitrogen content by a CHN elemental analysis is a method of burning a sample with oxygen for a certain period of time and then quantifying each of the amounts of carbon dioxide, water, and a nitrogen oxide generated, to quantify the amounts of carbon, hydrogen, and nitrogen atom contained in the sample. It is possible to evaluate the amount of the additive by comparing the amounts of nitrogen in samples before and after the introduction of the additive.

The method of extracting the additive from the electrochemical oxygen reduction catalyst and directly measuring the additive is a method of extracting an additive contained in the electrochemical oxygen reduction catalyst with a solvent that dissolves the additive and then subjecting the additive to a qualitative and quantitative analysis.

The analysis method includes chromatography, ultraviolet-visible spectroscopy (UV-vis), infrared spectroscopy (IR), nuclear magnetic resonance (NMR), and the like.

Evaluation Method for Metal Particle Weight

An evaluation method for the weight of the metal particles contained in the electrochemical oxygen reduction catalyst of the present disclosure includes thermogravimetric analysis (TG), high-frequency inductively coupled plasma emission spectroscopy (ICP), and the like.

Thermogravimetric analysis (TG) is a method of measuring a weight in a case where the gas atmosphere, the temperature, or the like is changed. The thermogravimetric analysis is a measurement method in which a weight remaining after carrying out heating to burn moisture, an electrical conductive carrier, a polymer having an ion exchange group, and impurities is taken as the weight of the metal particles.

High-frequency inductively coupled plasma emission spectroscopy (ICP) is a method of qualitatively and quantitatively analyzing contained elements from the wavelength and intensity of emitted rays emitted by atoms which have been subjected to plasma excitation. It is possible to directly quantify the weight of the metal particles contained in the electrochemical oxygen reduction catalyst.

Surface Modification Rate

In the electrochemical oxygen reduction catalyst of the present disclosure, the surface modification rate of the metal particles with the additive is less than 28% and may be 5% to 20%.

The surface modification rate can be obtained from the following expression.

Surface modification rate (%)=(surface area of metal particles modified with additive)/(surface area of metal particles before being subjected to surface modification with additive)

The surface area of the metal particles before being subjected to surface modification with the additive (the total surface area of metal particles) is the surface area of the metal particles in the sample before the introduction of the additive.

The surface area of the metal particles subjected to surface modification with the additive is (the surface area of the metal particles in the sample before the introduction of the additive)−(the surface area of the metal particles not subjected to surface modification with the additive in the sample after the introduction of the additive).

The surface area of the metal particles in the sample before the introduction of the additive can also be determined by a method of measuring the surface area of the metal particles in the sample after the additive has been liberated and extracted using a solvent in which the additive is soluble.

The evaluation method for the surface area of the metal particles includes, for example, a vapor phase gas adsorption method and an electrochemical substance adsorption method.

The vapor phase gas adsorption method is a method of introducing a gas that adsorbs to metal particles into a sample and measuring the surface area of the metal particles from the amount of the gas that has adsorbed. Representative examples of the adsorbing gas include carbon monoxide, carbon dioxide, nitrogen, and water.

The electrochemical substance adsorption method is a method of introducing a substance that adsorbs to metal particles into a sample and measuring the surface area of the metal particles from the amount of the substance that has adsorbed. The electrochemical substance adsorption method is a method of measuring the amount of the substance that has adsorbed, from the amount of electricity that flows when the substance adsorbs to and desorbs from the surface of the metal particle, and measuring the surface area of the metal particles. Representative examples of the adsorbing substance include carbon monoxide, hydrogen, and copper.

2. Air Electrode

In the present disclosure, the electrochemical oxygen reduction catalyst and an air electrode containing a polymer electrolyte having an ion exchange group are provided.

The air electrode of the present disclosure includes the electrochemical oxygen reduction catalyst of the present disclosure and a polymer electrolyte having an ion exchange group.

The air electrode of the present disclosure may be for a fuel cell or a metal-air cell.

The polymer electrolyte having an ion exchange group may be referred to as an electrolyte, an ionomer, or a binder. In the present disclosure, such a polymer electrolyte will be described hereinafter, as a binder. The binder may be any polymer that exchanges ions, and the binder may have sulfonic acid, phosphoric acid, quaternary ammonium cations, or the like as the ion exchange group. The binder may be a perfluorocarbon sulfonic acid polymer, may be an anion exchange polymer, or may be a polymer having a polyether ether ketone, a polybenzimidazole, or the like as a main component.

In the electrochemical oxygen reduction catalyst of the present disclosure, the ratio of the weight of the binder to the weight of the carrier may be more than 0 and may be 0.5 or more.

3. Fuel Cell

In the present disclosure, a fuel cell having the air electrode as a cathode is provided.

The fuel cell of the present disclosure has the air electrode of the present disclosure as a cathode.

In the fuel cell of the present disclosure, a configuration of a known fuel cell in the related art can be appropriately employed, except that the air electrode of the present disclosure is included as a cathode.

Since the fuel cell of the present disclosure uses, as a cathode, the air electrode containing the electrochemical oxygen reduction catalyst of the present disclosure, having high catalytic activity, it is possible to improve the power generation performance of the fuel cell.

4. Metal-Air Cell

In the present disclosure, a metal-air cell having the air electrode as a cathode is provided.

The metal-air cell of the present disclosure has the air electrode of the present disclosure as a cathode.

In the metal-air cell of the present disclosure, a configuration of a known metal-air cell in the related art can be appropriately employed, except that the air electrode of the present disclosure is included as a cathode.

Since the metal-air cell of the present disclosure uses, as a cathode, the air electrode containing the electrochemical oxygen reduction catalyst of the present disclosure, having high catalytic activity, it is possible to improve the power generation performance of the metal-air cell.

### Example 1

An electrochemical oxygen reduction catalyst containing a platinum cobalt alloy (ratio of metals other than platinum: 0.11 atm %) particles (metal particle diameter: 3 nm to 4 nm) as metal particles, 1,3,5-triazine-2,4,6-triamine (melamine, manufactured by FUJIFILM Wako Pure Chemical Corporation) as an additive, and carbon (metal support ratio: 48 wt %) as a carrier on which metal particles were supported was prepared.

Calculation of Weight of Additive with Respect to Weight of Metal Particles

The weight of the additive with respect to the weight of the metal particles (the weight of the additive)/(the weight of the metal particles) was calculated from the weights charged into the electrochemical oxygen reduction catalyst. The weight of the additive with respect to the weight of the metal particles was 0.010.

### Examples 2 to 4

An electrochemical oxygen reduction catalyst was prepared under the same conditions as in Example 1 except that the weight of the metal particles and the weight of the additive were adjusted so that the weight of the additive with respect to the weight of the metal particles was 0.052 in Example 2, 0.10 in Example 3, and 0.16 in Example 4.

### Example 5

An electrochemical oxygen reduction catalyst was prepared under the same conditions as in Example 1 except that a polymer of 1,3,5-triazine-2,4,6-triamine (melamine, manufactured by FUJIFILM Wako Pure Chemical Corporation) was used as an additive, and the weight of the metal particles and the weight of the additive were adjusted so that the weight of the additive with respect to the weight of the metal particles was 0.10.

### Examples 6 and 7, and Comparative Examples 1 and 2

An electrochemical oxygen reduction catalyst was prepared under the same conditions as in Example 1 except that platinum particles (metal particle diameter: 2 nm to 3 nm) were used as metal particles, and the weight of the metal particles and the weight of the additive were adjusted so that the metal support ratio was 18 wt % and the weight of the additive with respect to the weight of the metal particles was 0.046 in Example 6, 0.23 in Example 7, 0.46 in Comparative Example 1, and 0.69 in Comparative Example 2.

### Comparative Example 3

An electrochemical oxygen reduction catalyst was prepared under the same conditions as in Example 1 except that no additive was used. It is noted that since no additive is used, the weight of the additive with respect to the weight of the metal particles in Comparative Example 3 is 0.

### Comparative Example 4

An electrochemical oxygen reduction catalyst was prepared under the same conditions as in Example 5 except that no additive was used. It is noted that since no additive is used, the weight of the additive with respect to the weight of the metal particles in Comparative Example 4 is 0.

Production of Electrode for Evaluation

Each of the electrochemical oxygen reduction catalysts in Examples 1 to 7 and Comparative Examples 1 to 4 and a perfluorocarbon sulfonic acid polymer (DE520 manufactured by FUJIFILM Wako Pure Chemical Corporation) as a binder were dispersed in a mixed solvent of 2-propanol and ultrapure water. The dispersion liquid was dropped onto a glassy carbon rotation electrode (diameter: 5 mm) manufactured by HOKUTO DENKO Corporation so that the carrier amount was 20 μg/cm², and dried to prepare an electrode for evaluation. The weight of the binder with respect to the weight of the carbon (−) as a carrier in the electrode for evaluation was set to be 0.5.

Evaluation of Catalyst Mass Activity

An electrochemical measurement was carried out in a three-electrode system using each produced electrode for evaluation as a working electrode, a reversible hydrogen electrode as a reference electrode, and a carbon rod as a counter electrode.

As an electrolytic solution, a perchloric acid aqueous solution adjusted to 0.1 M with ultrapure water was used.

Cyclic voltammetry was carried out under an inert gas atmosphere.

Then, the gas atmosphere was changed to oxygen, and linear sweep voltammetry was carried out from the low potential side.

The linear sweep voltammetry measurement was repeated by changing the electrode rotation speed to 400, 900, 1,600, 2,000, 2,500, and 3,600 rpm.

A Kouteckey-Levich plot was created from the obtained potential-current characteristics, and the catalyst mass activity (A/g) during 0.9 Vv. s. RHE was calculated.

The catalyst mass activity is the current per weight of metal particles. The current is a value that indicates the reaction rate of the electrochemical reaction, where it is meant that the higher the current, the higher the catalytic activity.

In addition, the catalyst mass activity of the electrochemical oxygen reduction catalyst containing the additive (the catalyst mass activity of the electrochemical oxygen reduction catalyst after introducing the additive) and the catalyst mass activity of the electrochemical oxygen reduction catalyst having the same configuration except that the additive is not contained (the catalyst mass activity of the electrochemical oxygen reduction catalyst before introducing the additive) were each calculated, and from these catalyst mass activities, the improvement rate of the catalyst mass activity was calculated.

The improvement rate of the catalyst mass activity is defined as (the catalyst mass activity of the electrochemical oxygen reduction catalyst after introducing the additive)/(the catalyst mass activity of the electrochemical oxygen reduction catalyst before introducing the additive).

By using the additive-free electrochemical oxygen reduction catalyst of Comparative Example 3 as the electrochemical oxygen reduction catalyst before the introduction of the additive, the improvement rate of the catalyst mass activity of each of the electrochemical oxygen reduction catalysts in Examples 1 to 5 was calculated as a ratio of the catalyst mass activity of each of the electrochemical oxygen reduction catalysts after the introduction of the additive in Examples 1 to 5 relative to the catalyst mass activity of the electrochemical oxygen reduction catalyst before the introduction of the additive.

By using the additive-free electrochemical oxygen reduction catalyst in Comparative Example 4 as the electrochemical oxygen reduction catalyst before the introduction of the additive, the improvement rate of the catalyst mass activity of each of the electrochemical oxygen reduction catalysts in Examples 6 and 7 and Comparative Examples 1 and 2 was calculated as a ratio of the catalyst mass activity of each of the electrochemical oxygen reduction catalysts after the introduction of the additive in Examples 6 and 7 and Comparative Examples 1 and 2 relative to the catalyst mass activity of the electrochemical oxygen reduction catalyst before the introduction of the additive. The results are shown in Tables 1 to 3.

Calculation of Surface Modification Rate

The surface area of the metal particles subjected to surface modification with the additive was calculated from the hydrogen adsorption current value of the reduction wave in the cyclic voltammogram of the electrode for evaluation containing the electrochemical oxygen reduction catalyst into which the additive was introduced.

The surface area of the metal particles (the total surface area of metal particles) before being subjected to surface modification with the additive was calculated from the hydrogen adsorption current value of the reduction wave in the cyclic voltammogram of the electrode for evaluation containing the electrochemical oxygen reduction catalyst into which the additive was not introduced.

From these surface areas, the surface modification rate of the electrochemical oxygen reduction catalyst into which the additive was introduced (the surface area of the metal particles subjected to surface modification with the additive)/(the surface area of the metal particles before being subjected to surface modification with the additive) was calculated.

The surface modification rate of each of the electrochemical oxygen reduction catalysts in Examples 1 to 5 was calculated as a ratio of the surface area of the metal particles of each of the electrochemical oxygen reduction catalysts which contained the additive in Examples 1 to 5, where the metal particles had been subjected to surface modification with the additive, relative to the total surface area of metal particles of the electrochemical oxygen reduction catalyst which did not contain the additive in Comparative Example 3.

The surface modification rate of each of the electrochemical oxygen reduction catalysts in Examples 6 and 7 and Comparative Examples 1 and 2 was calculated as a ratio of the surface area of the metal particles of each of the electrochemical oxygen reduction catalysts which contained the additive in Examples 6 and 7 and Comparative Examples 1 and 2, where the metal particles had been subjected to surface modification with the additive, relative to the total surface area of metal particles of the electrochemical oxygen reduction catalyst which did not contain the additive in Comparative Example 4. The results are shown in Tables 1 to 3.

TABLE 1

| | Example 1 | Example 2 | Example 3 | Example 4 |
|---|---|---|---|---|
| Metal particle | Platinum cobalt | Platinum cobalt | Platinum cobalt | Platinum cobalt |
| | alloy | alloy | alloy | alloy |
| Ratio of metals other | 0.11 atm % | 0.11 atm % | 0.11 atm % | 0.11 atm % |
| than platinum | | | | |
| Metal support ratio | 48 wt % | 48 wt % | 48 wt % | 48 wt % |
| Metal particle diameter | 3 nm to 4 nm | 3 nm to 4 nm | 3 nm to 4 nm | 3 nm to 4 nm |
| Carrier | Carbon | Carbon | Carbon | Carbon |
| Binder | Perfluorocarbon | Perfluorocarbon | Perfluorocarbon | Perfluorocarbon |
| | sulfonic acid | sulfonic acid | sulfonic acid | sulfonic acid |
| | polymer | polymer | polymer | polymer |
| Weight of binder with | 0.5 | 0.5 | 0.5 | 0.5 |
| respect to weight of | | | | |
| carbon (—) | | | | |
| Additive | 1,3,5-triazine- | 1,3,5-triazine- | 1,3,5-triazine- | 1,3,5-triazine- |
| | 2,4,6-triamine | 2,4,6-triamine | 2,4,6-triamine | 2,4,6-triamine |
| Proportion of weight of | 0.010 | 0.052 | 0.10 | 0.16 |
| additive with respect to | | | | |
| weight of metal | | | | |
| particles (—) | | | | |
| Surface modification | 13 | 8.8 | 8.8 | 12 |
| rate (%) | | | | |
| Improvement rate | 2.2 | 3.3 | 4.1 | 3.2 |
| of catalyst mass | | | | |
| activity (—) | | | | |

TABLE 2

| | Example 5 | | Example 6 | | Example 7 | |
|---|---|---|---|---|---|---|
| Metal particle | Platinum cobalt | | Platinum | | Platinum | |
| | alloy | | | | | |
| Ratio of metals other | 0.11 | atm % | 0.00 | atm % | 0.00 | atm % |
| than platinum | | | | | | |
| Metal support ratio | 48 | wt % | 18 | wt % | 18 | wt % |
| Metal particle diameter | 3 nm to 4 nm | | 2 nm to 3 nm | | 2 nm to 3 nm | |
| Carrier | Carbon | | Carbon | | Carbon | |
| Binder | Perfluorocarbon | | Perfluorocarbon | | Perfluorocarbon | |
| | sulfonic acid | | sulfonic acid | | sulfonic acid | |
| | polymer | | polymer | | polymer | |
| Weight of binder with | 0.5 | | 0.5 | | 0.5 | |
| respect to weight | | | | | | |
| of carbon (—) | | | | | | |
| Additive | 1,3,5-triazine- | | 1,3,5-triazine- | | 1,3,5-triazine- | |
| | 2,4,6-triamine | | 2,4,6-triamine | | 2,4,6-triamine | |
| | polymer | | | | | |
| Proportion of weight of | 0.10 | | 0.046 | | 0.23 | |
| additive with respect to | | | | | | |
| weight of metal | | | | | | |
| particles (—) | | | | | | |
| Surface modification | 5.0 | | 14 | | 20 | |
| rate (%) | | | | | | |
| Improvement rate | 4.0 | | 1.5 | | 1.6 | |
| of catalyst mass | | | | | | |
| activity (—) | | | | | | |

TABLE 3

| | Comparative | | Comparative | | Comparative | | Comparative | |
|---|---|---|---|---|---|---|---|---|
| | Example 1 | | Example 2 | | Example 3 | | Example 4 | |
| Metal particle | Platinum | | Platinum | | Platinum cobalt | | Platinum | |
| | | | | | alloy | | | |
| Ratio of metals other | 0.00 | atm % | 0.00 | atm % | 0.11 | atm % | 0.00 | atm % |
| than platinum | | | | | | | | |
| Metal support ratio | 18 | wt % | 18 | wt % | 48 | wt % | 18 | wt % |
| Metal particle | 2 nm to 3 nm | | 2 nm to 3 nm | | 3 nm to 4 nm | | 2 nm to 3 nm | |
| diameter | | | | | | | | |
| Carrier | Carbon | | Carbon | | Carbon | | Carbon | |
| Binder | Perfluorocarbon | | Perfluorocarbon | | Perfluorocarbon | | Perfluorocarbon | |
| | sulfonic acid | | sulfonic acid | | sulfonic acid | | sulfonic acid | |
| | polymer | | polymer | | polymer | | polymer | |
| Weight of binder with | 0.5 | | 0.5 | | 0.5 | | 0.5 | |
| respect to weight of | | | | | | | | |
| carbon (—) | | | | | | | | |
| Additive | 1,3,5-triazine- | | 1,3,5-triazine- | | Absent | | Absent | |
| | 2,4,6-triamine | | 2,4,6-triamine | | | | | |
| Proportion of weight of | 0.46 | | 0.69 | | 0.0 | | 0.0 | |
| additive with respect to | | | | | | | | |
| weight of metal | | | | | | | | |
| particles (—) | | | | | | | | |
| Surface modification | 28 | | 2 | | 0.0 | | 0.0 | |
| rate (%) | | | | | | | | |
| Improvement rate | 0.90 | | 0.81 | | 1.0 | | 1.0 | |
| of catalyst mass | | | | | | | | |
| activity (—) | | | | | | | | |

Evaluation Results

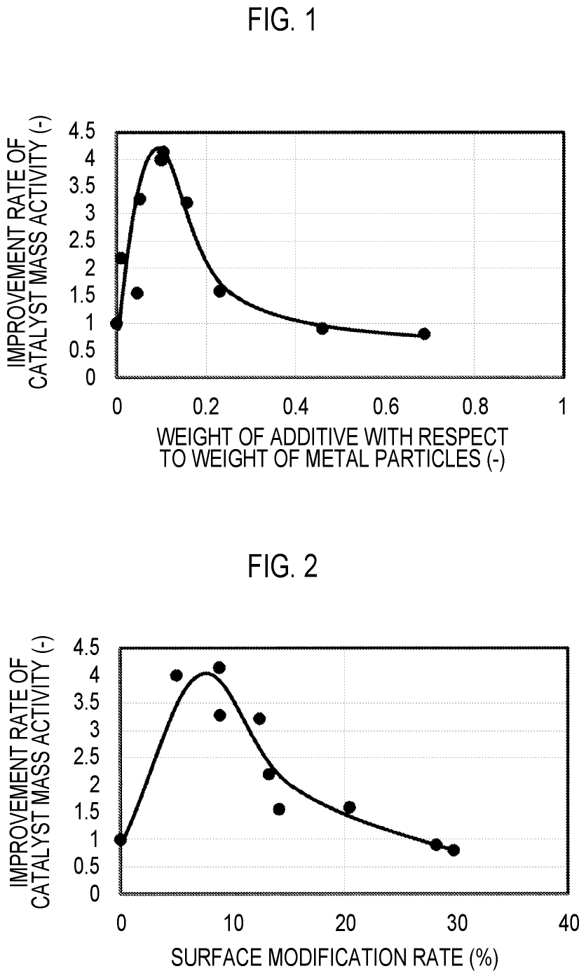

FIG. 1 is a graph showing a relationship between a weight of an additive with respect to a weight of metal particles and an improvement rate of catalyst mass activity.

FIG. 2 is a graph showing a relationship between a surface modification rate and the improvement rate of the catalyst mass activity.

As shown in FIGS. 1 and 2 and Table 1 to Table 3, it can be seen that in Examples 1 to 7, the improvement rate of the catalyst mass activity is high as compared with Comparative Examples 1 to 4.

From the above results, it has been demonstrated that it is possible to improve the catalytic activity of the electrochemical oxygen reduction catalyst in a case of satisfying at least any one of the condition that the ratio of the weight of the additive to the weight of the metal particles is more than 0 and less than 0.46 and the condition that the surface modification rate of the metal particles with the additive is less than 28%

What is claimed is:

1. An electrochemical oxygen reduction catalyst comprising:
metal particles having oxygen reduction activity; and
an additive, wherein:
the additive is at least one organic nitrogen compound; and
a ratio of a weight of the additive to a weight of the metal particles is more than 0 and less than 0.46.

2. The electrochemical oxygen reduction catalyst according to claim 1, wherein the ratio of the weight of the additive to the weight of the metal particles is 0.052 or more and 0.1 or less.

3. The electrochemical oxygen reduction catalyst according to claim 1, wherein the organic nitrogen compound is a monomer represented by General Formula (1), or a polymer at least partially containing the monomer, 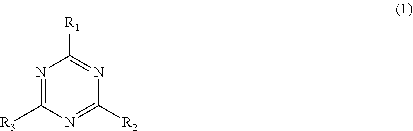
in General Formula (1), R₁, R₂, and R₃ are each an amino group, a thiol group, a hydroxyl group, an alkylamino group having 1 to 10 carbon atoms, or an alkyl group having 1 to 10 carbon atoms, and each have at least one atom selected from the group consisting of an oxygen atom, a sulfur atom, a nitrogen atom, a fluorine atom, a chlorine atom, a bromine atom, an iodine atom, and a hydrogen atom.

4. The electrochemical oxygen reduction catalyst according to claim 1, wherein the metal particle is at least one selected from the group consisting of a platinum particle, a platinum alloy particle, and a composite particle containing platinum.

5. The electrochemical oxygen reduction catalyst according to claim 1, further comprising a carrier, wherein the metal particles are supported on the carrier.

6. An air electrode comprising:
the electrochemical oxygen reduction catalyst according to claim 1; and
a polymer electrolyte having an ion exchange group.

7. An electrochemical oxygen reduction catalyst comprising:
metal particles having oxygen reduction activity; and
an additive, wherein:
the additive is at least one organic nitrogen compound; and
a surface modification rate of the metal particles with the additive is less than 28%.

8. The electrochemical oxygen reduction catalyst according to claim 7, wherein the surface modification rate of the metal particles with the additive is 5% or more and 12% or less.

9. The electrochemical oxygen reduction catalyst according to claim 8, wherein the surface modification rate of the metal particles with the additive is 5% or more and 8.8% or less.

10. The electrochemical oxygen reduction catalyst according to claim 7, wherein the organic nitrogen compound is a monomer represented by General Formula (1), or a polymer at least partially containing the monomer, 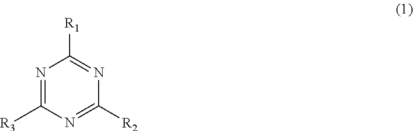
in General Formula (1), R₁, R₂, and R₃ are each an amino group, a thiol group, a hydroxyl group, an alkylamino group having 1 to 10 carbon atoms, or an alkyl group having 1 to 10 carbon atoms, and each have at least one atom selected from the group consisting of an oxygen atom, a sulfur atom, a nitrogen atom, a fluorine atom, a chlorine atom, a bromine atom, an iodine atom, and a hydrogen atom.

11. The electrochemical oxygen reduction catalyst according to claim 7, wherein the metal particle is at least one selected from the group consisting of a platinum particle, a platinum alloy particle, and a composite particle containing platinum.

12. The electrochemical oxygen reduction catalyst according to claim 7, further comprising a carrier, wherein the metal particles are supported on the carrier.

13. An air electrode comprising:
the electrochemical oxygen reduction catalyst according to claim 1; and
a polymer electrolyte having an ion exchange group.

14. The air electrode according to claim 13, wherein the air electrode is for a fuel cell or a metal-air cell.

15. A fuel cell comprising the air electrode according to claim 13 as a cathode.

16. A metal-air cell comprising the air electrode according to claim 13 as a cathode.

17. An air electrode comprising:
the electrochemical oxygen reduction catalyst according to claim 7; and
a polymer electrolyte having an ion exchange group.

18. The air electrode according to claim 17, wherein the air electrode is for a fuel cell or a metal-air cell.

19. A fuel cell comprising the air electrode according to claim 17 as a cathode.

20. A metal-air cell comprising the air electrode according to claim 17 as a cathode.
